(19) United States
(12) Patent Application Publication
(10) Pub. No.: US 2003/0163674 A1
(43) Pub. Date: Aug. 28, 2003

(54) Data processing apparatus, processor unit and debugging unit

(76) Inventors: Mitsumasa Yoshimura, Tokyo (JP); Takeshi Satou, Tokyo (JP)

Correspondence Address: BURNS, DOANE, SWECKER & MATHIS, L.L.P, P.O. Box 1404, Alexandria, VA, 22313-1404, US

(21) Appl. No.: 10/368,485

(22) Filed: Feb. 20, 2003

(30) Foreign Application Priority Data
Feb. 26, 2002 (JP) 2002-49981

(51) Int. Cl. G06F 9/00

(52) U.S. Cl. 712/227

(57) ABSTRACT

A processor unit equipped with an interface for externally outputting next instruction pointer data and next instruction code data from the processor unit is provided. With this processor unit, when a debugging unit is incorporated into a system LSI, the debugging unit can judge the break condition using the next instruction pointer data and the next instruction code data supplied from the processor unit for external use, so that duplicated hardware can be omitted.

### BACKGROUND OF THE INVENTION

1. Technical Field

The present invention relates to a processor that is embedded in a data processing apparatus such as a large scale integrated circuit (hereinafter “LSI”).

2. Description of the Related Art

It is now possible to manufacture large-scale system LSIs, so that an entire system can be constructed on a single chip. This has resulted in the development of system LSIs where the processor (processor unit), which is required to construct a system, and functions, which have been developed for a special-purpose LSI to achieve optimal performance for the intended purpose, are implemented in a single semiconductor chip. Processors that have been developed for such large-scale system LSIs are called “embedded processors”.

The intent of the embedded processors should be fundamentally different from conventional single-chip CPUs. However, there are no clear differences that make it possible to distinguish the embedded processors that are currently available from processors that are used as single-chip CPUs.

The largest difference is that embedded processors need to have a variety of optional functions. This is to say, a conventional CPU (or packaged CPU product) with a single-chip construction needs to satisfy the needs of a wide range of users, so that all of the functions that are thought to be necessary are implemented in advance. On the other hand, an embedded processor that is embedded in a system LSI only needs to be equipped with the functions that are necessary for that particular system LSI. This means that the functions that conventionally provided as a single processor are converted into optional modules. By implementing a processor unit and modularized functions in a single system LSI, a processor with the desired functions can be constructed within a system LSI.

In view of the above, the standard debugging module (debugging function) that is internally provided in a conventional CPU should preferably be provided to an embedded processor unit in the form of a separate unit that can be embedded in a system LSI as an option. A debugging unit is hardware that operates as follows. By a personal computer or the like, instruction pointer data or instruction code data that is a target for causing a break (temporary halting) to the processor can be set. During the execution of a program on the processor, when the processor finds the instruction pointer data or instruction code data that is the break condition, the debugging unit has the processing of the processor unit temporarily halted. Once the processing has been halted, debugging is performed by observing the contents of the internal registers of the processor and/or inserting special values into the internal registers.

When a debugging unit is provided as an optional module, it is preferable for the control of the debugging unit to be performed independently of the embedded processor, since this increases the reliability of the debugging. Debugging software that operates the debugging unit can be executed on a personal computer. Debugging software for a conventional packaged CPU product is made under the assumption that a debugger is included in the CPU. In the case of an embedded processor, however, a debugger is provided or not provided depending on the user specification. This means that software developed under the assumption of a debugger being present may be unsuitable or even completely redundant. In addition, when software that has been developed for a system with a debugger is executed by a system that does not include a debugger, this can cause system errors, which lowers the reliability.

On the other hand, when a debugging unit is operated independently of the processing unit, in order to halt the processing unit in accordance with the content of the instruction bus (the instruction pointer and instruction code) which forms the break condition, it is necessary to provide the debugging unit with the same fetch and decode functions as the processor unit for generating the instruction code and instruction pointer. This means that to provide a system LSI with a debugging function, it is necessary to provide a debugging unit with a complicated construction and relatively large-scale circuitry. In view of the entire system LSI, two sets of hardware for fetch and decode operations are provided. In particular, when a processing unit that is compatible with unspecified-length (or variable-length) instructions that are between 1 and 2 words long is provided, the functions described below need to be provided for fetching and decoding, which increases the scale of the hardware that needs to be duplicated.

In cases where the bus width of the data bus on which instruction codes are outputted does not match the instruction length, it is not clear where the next instruction code data begins in the data fetched, and there is the possibility of the next instruction code data straddling pieces of fetched data. Accordingly, in order to judge whether the instruction pointer data that causes a break matches the instruction pointer that is used to fetch data that include the instruction code, a function that monitors the length of each instruction and determines the position of the next instruction pointer is required. Also, in cases where the width of the data bus does not match the instruction length, when branching has occurred, the branch destination address does not always match the fetch address, so that a function that makes a suitable adjustment and determines the position of the next instruction pointer is required. In addition, when the width of the data bus does not match the instruction length, as described above a function that selects and lines up the next instruction code data from the fetched data and/or aligns the next instruction code data from consecutive pieces of fetched data is required.

In addition to such functions, the functions described below are also required for the debugging unit to appropriately determine the instruction code that is to be executed next by the execution unit of the processor. When the instruction codes include multicycle instruction codes whose execution consumes a plurality of execution cycles or clocks, the timing at which the next instruction code will be executed by the execution unit is unclear. This means that a function for detecting the timing from the fetching of an instruction to the execution of that instruction is required. When a processor is made capable of such multicycle instruction processes, the scale of the hardware becomes extremely large.

When a branch occurs, even if an instruction code has previously been fetched, this pre-executing instruction code is not executed by the execution unit and so is not the next instruction code. Since it is meaningless to output a debugging break signal for an instruction code that is not executed, a function that judges whether a branch has occurred is also required.

Hardware that is capable of such functions has a large scale, so that it is desirable to omit such hardware in order to reduce the size and cost of the system LSI. Such functions are fundamentally supported by the hardware of the processor unit as the fetch function of the processing unit, which means that the same hardware becomes duplicated in the system LSI.

Developing an embedded processor that includes a debugging function and another embedded processor that does not include a debugging function is duplicate investing for duplicated parts. When the functions of the processors are changed or improved, there is the significant burden of having to simultaneously upgrade both the processor with the debugging function and the processor without the debugging function, again resulting in a large investment in duplicated resources. It is also necessary to use resources to develop and maintain two sets of software, software for a processor equipped with a debugging function and software for a processor that is not equipped with the debugging function. In view of such demerits, it is possible to conclude that hardware with a certain degree of duplication between the debugging unit and the processing unit is acceptable.

It is an object of the present invention to provide a system LSI where a debugging unit can be implemented as an option and where hardware that is the same as in the processor unit can be omitted from the debugging unit. It is an object of the present invention to avoid having to design, develop, and maintain two sets of hardware and software to providing debugging function. It is another object of the present invention to make it possible to provide compact system LSIs at a low cost.

### SUMMARY OF THE INVENTION

The present invention provides, as an embedded processor unit, a processor unit equipped with an interface for externally outputting next instruction pointer data and next instruction code data from the processor unit. With this processor unit, when a debugging unit is incorporated into a system LSI, the debugging unit can judge the break condition using the next instruction pointer data and/or the next instruction code data supplied from the processor unit for external use, so that duplicated hardware can be omitted. The processor unit only needs to output the next instruction pointer data and next instruction code data irrespective of whether the debugging unit is present or not, so that hardware and software can be designed, developed and maintained without being affected by the presence or absence of the debugging unit.

In more detail, the present invention provides a processor unit including a fetch unit for outputting a fetch address based on instruction pointer data and generating instruction code data from data obtained using the fetch address, an execution unit for executing processing based on the instruction code data, a first output means for externally outputting next instruction pointer data for next instruction code data, which is to be executed next by the execution unit, from the processor unit, and a second output means for externally outputting next instruction code data from the processor unit. A debugging unit according to this invention can be operated by combining this processor unit. The debugging unit includes a break signal output means for supplying a break signal for requesting a temporary halt of a processor unit when a break condition is satisfied, a first input means for receiving the next instruction pointer data for comparing with target instruction pointer data that is set as the break condition, from external to the debugging unit; and a second input means for receiving the next instruction code data for comparing with target instruction code data that is set as the break condition, from external to the debugging unit.

According to the present invention, a method of controlling a debugging unit is also supplied. The method of controlling the debugging unit has a break requesting step for supplying a break signal, which requests a temporary halt of a processor unit, when a break condition is satisfied. The method also includes a step of receiving a next instruction pointer data for comparing with target instruction pointer data that is set as the break condition and/or a next instruction code data for comparing with target instruction code data that is set as the break condition, from external to the debugging unit. The debugging unit does not require hardware that is the equivalent of the fetch unit of the processor unit.

A data processing apparatus that includes the processor unit of the present invention can adopt a debugging function by equipping with the debugging unit of this invention without duplicating hardware that corresponds to a fetch unit. The debugging unit is an optional unit and the processor unit can work without debugging unit. Therefore, the processor unit of the present invention can be used as an embedded processor to form a data processing apparatus such as a system LSI with or without debugging unit.

When a program includes multicycle instruction codes, it is necessary to determine the execution start time for the next instruction code data. Also, to avoid the issuing of unnecessary break signals when a branch has occurred, it is preferable to judge when a break signal is required just before the execution of the next instruction code data. Accordingly, it is more preferable for the processor unit to include a third output means for externally outputting timing, at which processing based on the next instruction code data is to start, from the processor unit. The timing at which the processing based on the next instruction code data is to start is the timing at which processing based on the present instruction code data is completed in the execution unit, so that this timing may be externally outputted from the processor unit. Corresponding to this, the debugging unit includes a third input means for receiving the timing at which the execution of the next instruction code data starts, and the break signal output means outputs the break signal at a start of execution of the next instruction code data when at least one of the target instruction pointer data and the target instruction code data respectively matches the next instruction pointer data and the next instruction code data. A method of controlling a debugging unit further comprising a step of receiving timing, at which execution based on the next instruction code data is to start, from external to the debugging unit. In addition, in the break requesting step, the break signal is output at a start of the execution of the next instruction code data when at least one of the target instruction pointer data and the target instruction code data respectively matches the next instruction pointer data and the next instruction code data.

The applicant of the present invention has proposed a data processing apparatus (system LSI), that includes a special-purpose processing unit equipped with a special-purpose circuit suited to or dedicated to special-purpose processing. In this data processing apparatus, the fetch unit of the processor unit supplies general-purpose instruction code data, which designates processing in the processor unit, as the instruction code data to the execution unit, and supplies special-purpose instruction code data, which designates processing in the special-purpose processing unit, as the instruction code data to the special-purpose processing unit. The processor unit of the present invention can be used as an embedded processor in such a system LSI, which makes it possible to add a debugging unit at low cost.

### BRIEF DESCRIPTION OF THE DRAWINGS

These and other objects, advantages and features of the invention will become apparent from the following description thereof taken in conjunction with the accompanying drawings which illustrate a specific embodiment of the invention. In the drawings:

FIG. 1 shows the outline construction of an LSI-mounted system board on which a data processing apparatus according to the present invention is mounted;

FIG. 2 is a block diagram showing an outline of the data processing apparatus according to the present invention;

FIG. 3 is a diagram showing the signals exchanged between the PU and the DU;

FIG. 4 shows the PU and the DU in more detail;

FIG. 5 is a flowchart showing the debugging process performed by the PU and the DU; and

FIG. 6 is a timing chart showing the processing that halts the processing of the execution unit of the PU when the break condition is satisfied in the DU.

### DESCRIPTION OF THE PREFERRED EMBODIMENT

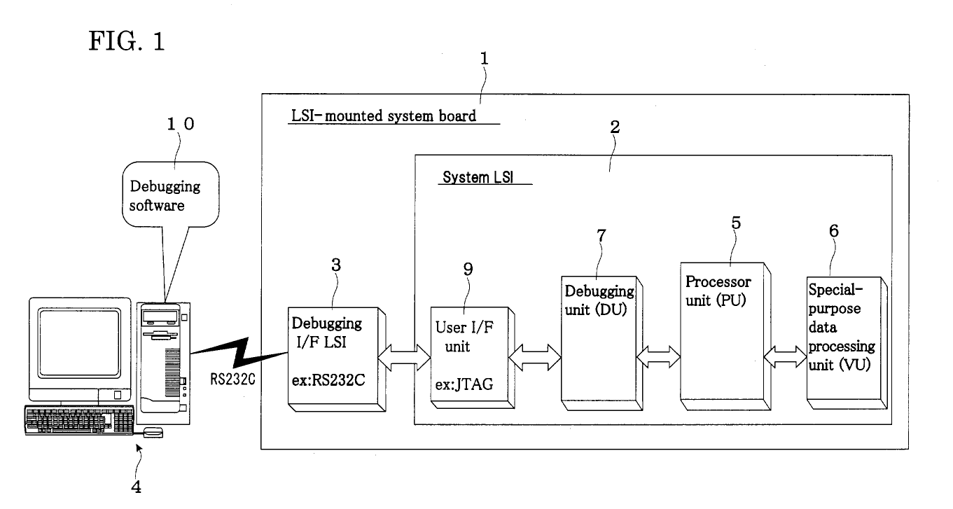

The following describes the present invention in detail with reference to the attached drawings. FIG. 1 shows the outline of a data processing apparatus or system that includes a processor unit according to the present invention. In this case, a system LSI 2 that is the data processing apparatus of this invention is mounted on a system board 1. The system LSI 2 mounted on the system board 1 is an LSI with an architecture called a “VUPU” therefore the LSI 2 hereinafter called as “VUPU”. The VUPU2 has been proposed by the present applicant and this architecture includes a processor unit or general-purpose data processing unit (hereinafter “PU”) 5 and a special-purpose data processing unit (hereinafter “VU”) 6 that is dedicated to special-purpose processing. The VUPU 2 of the present embodiment also includes a debugging unit (hereinafter “DU”) 7 that performs debugging for the PU 5 and a user interface 9 that inputs and outputs signals into and out of the DU 7. A JTAG boundary-scan test interface can be used as the user interface 9, so that via a debugging interface 3 provided on the system board 1, the DU 7 can be controlled by debugging software 10 that is executed on a personal computer 4.

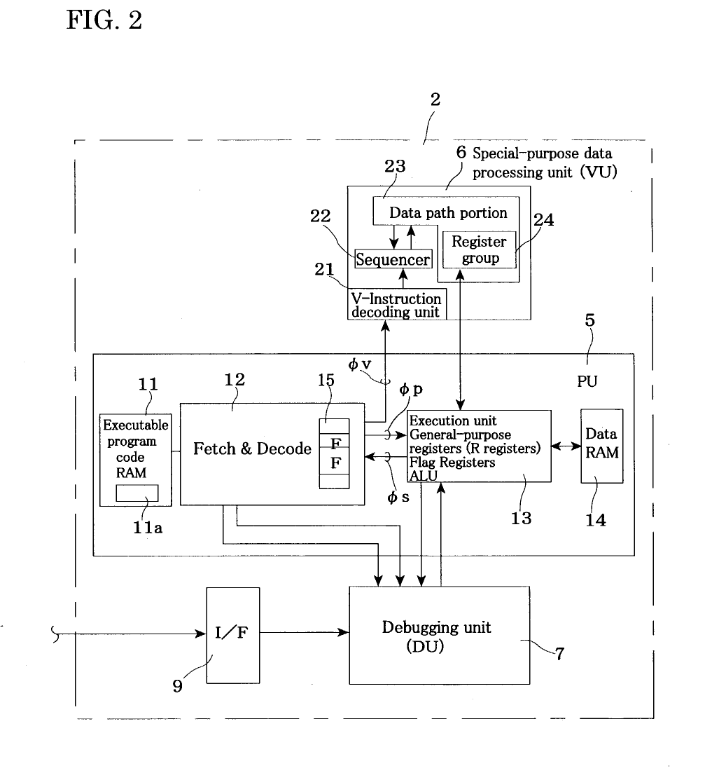

FIG. 2 is a block diagram showing an outline of the VUPU 2. The VUPU 2 is an LSI where the VU 6 is controlled via the PU 5 by a program, with the PU 5 as an embedded processor. The PU 5 is a processor unit with a general-purpose construction, and includes a code RAM that stores executable program code (microprogram code) 11a, and a fetch unit (FU) 12 that fetches an instruction from this code RAM 11 and provides an execution unit (EU) 13 of the PU 5 and the VU 6 with decoded control signals. The PU 5 also includes an execution unit 13 with widespread applicability that is constructed of general-purpose registers, flag registers, and an operation unit (ALU), etc. The PU 5 performs general-purpose processing while inputting and outputting data to and from a data RAM 14 as a temporary storage area.

The fetch unit 12 calculates the fetch address from an instruction pointer that is determined by a previous instruction, or the state of the state register 15, an interrupt signal, etc., and fetches data including an instruction code from a predetermined address in the code RAM 11. The fetch unit also decodes the fetched data, generates a special-purpose instruction (VU instruction) or a general-purpose instruction (standard instruction or PU instruction) from the data obtained from the code RAM 11 using the fetch address, supplies a VU instruction to the VU 6 as a control signal (Decoded Control Signal) φv, and supplies a PU instruction to the execution unit 13 as a control signal (Decoded Control Signal) φp. A status signal (Exec unit status signal) φs that shows the execution status is sent back from the execution unit 13, and the execution results of the execution unit 13 and the VU 6 are reflected in a status register 15. As one example, when the branch condition is satisfied for the execution unit 13, the fetch unit 12 fetches the instruction code of the branch destination in accordance with the branch.

In the VUPU 2, the execution unit 13 of the PU 2 and the VU 6 are processing units that are on the same level for the fetch unit 12. This means that the fetch unit 12 is an instruction issuing unit that is common to both the execution unit 13 and the VU 6, so that, in the VUPU architecture, the execution unit 13 can be thought of as PU that can be compared with the VU 6.

The VU 6 that executes the VU instruction φv includes a unit 21 that selects a VU instruction φv that is directed to this unit and decodes the selected VU instruction φv, a sequencer (FSM (Finite State Machine)) 22 that outputs, using hardware, control signals that have predetermined data processing executed, and a data path portion 23 that has been designed so as to perform the predetermined data processing in accordance with the control signals from the sequencer 22. The VU 6 includes a register 24 that can be accessed from the PU 5. The PU 5 can control, via this interface register 24, data that is required by the processing by the data path unit 23. The PU 5 can also refer to the internal status of the VU 6 via the register 24. The PU 5 can execute processing using the result of the processing by the data path unit 23.

A program 11a that includes general-purpose instructions (PU instructions) and special-purpose instructions (VU instructions) is stored in the code RAM 11, with the fetch unit 12 supplying control signals φv according to the VU instructions for activating the VU 6 to the VU 6 and the VU instruction decoder 21 selecting these control signals φv and operating. The control signals φv and the VU instructions are sometime the same in this specification. On the other hand, only control signals φp that are produced by decoding PU instructions are supplied to the execution unit 13. The control signals φp and the PU instructions are sometime the same in this specification. The control signals φv produced by decoding VU instructions are not issued to the execution unit 13, with control signals showing a nop instruction that is not executed being issued in place of the control signals φv so that the execution unit 13 skips the processing. Accordingly, VU instructions that cannot be interpreted by the execution unit 13 are not supplied to the execution unit 13, so that a program 11a that includes a new VU instruction or a variety of VU instructions can be executed by the VUPU 2 without changing the construction of the PU 5.

This is to say, there are many cases where the VU 6 of the VUPU 2 changes in accordance with the application, etc., with the VU instructions that give indications to the VU 6 also changing in accordance with the application. On the other hand, since a nop instruction is outputted to the PU 5, the PU 5 does not need to handle instructions that are dedicated to the VU, and a function that interprets the basic instructions and general-purpose instructions that compose the PU instructions is sufficient for the PU 5. This means that the PU 5 functions as a general-purpose embedded processor that serves as a platform on which the VU 6 operates. In a system LSI composed of the combination of a PU 5, which is general-purpose, and the VU 6, which includes special-purpose circuitry, the VU 6 can be controlled by a program via the PU 5. This reduces the time required for design and development of the system LSI without sacrificing real-time response, and makes it possible to flexibly handle changes, modification and revisions made at a later date. Accordingly, an important benefit with the VUPU 2 is the ability to implement a variety of optional functions while maintaining the general-purpose applicability of the PU 5.

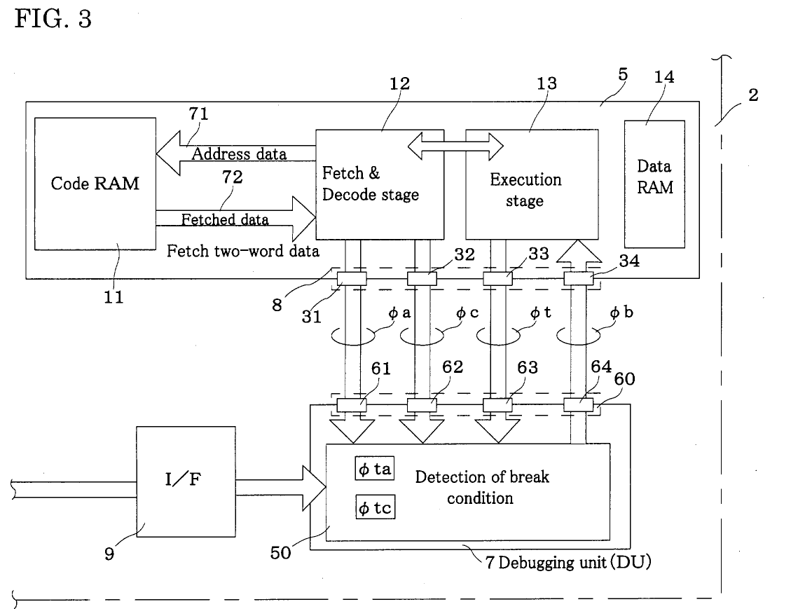

With the VUPU 2 of the present embodiment, the debugging unit (DU) 7 is implemented as an optional unit. FIG. 3 shows the signals exchanged between the PU 5 and the DU 7. The PU 5 includes wiring or a connection terminal 32 that acts as the second output means and externally outputs the next instruction code data φc that has been fetched and decoded by the fetch unit 12 and is to be supplied to the execution unit 13 at the next timing, and wiring or a connection terminal 31 that act as the first output means and externally outputs the next instruction pointer data φa that shows the next instruction code data φc. The PU 5 also includes wiring or a connection terminal 33 that act as the third output means and externally outputs a signal φt showing the timing at which the execution unit 13 commences execution of the processing based on the next instruction code data φc. This signal φt that shows the timing at which execution of the next instruction commences, namely that shows the timing for the latching of the next instruction according to the completion of an instruction by the execution unit 13.

The PU 5 also includes wiring or a connection terminal 34 that receives a break signal φb from the DU 7. When the break signal φb is received from the DU 7, the PU 5 stops the processing in the execution unit 13 that is based on the instruction code data.

Corresponding to a debugging interface 8 that provides on the processing unit 5 for external use to the processing unit 5 and includes these connection terminals 31, 32, 33, and 34, the DU 7 is provided with an interface 60 that includes a connection terminal 61 that acts as the first input means and receives the next instruction pointer data φa, a connection terminal 62 that acts as the second input means and receives the next instruction code data φc, a connection terminal 63 that acts as the third input means and receives the timing signal φt for the start of execution, and a connection terminal 64 for outputting the break signal φb. A break condition match detecting function 50 of the DU 7 outputs the break signal φb when the target instruction pointer data φta that has been set via the user interface 9 matches the received next instruction pointer data φa, the target instruction code data φtc that has been set matches the received next instruction code data φc, and according to the timing signal φt this next instruction code data φc enters a state where execution is to be commenced.

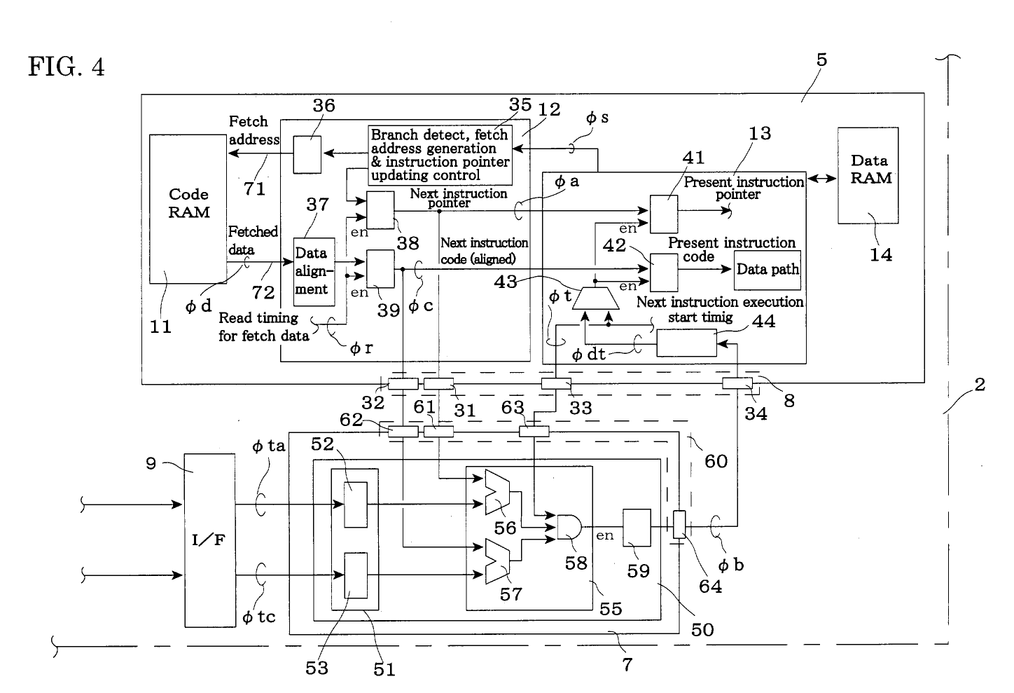

FIG. 4 shows the constructions of the PU 5 and the DU 7 relating to these signals in more detail. The fetch unit 12 of the PU 5 includes a next instruction pointer generating unit 35 that generates a fetch address for obtaining the next instruction code based on a fetched and decoded instruction and a status signal φs from the execution unit 13. The next instruction pointer generating unit 35 has a function for updating the instruction pointer data and calculating a fetch address from the instruction pointer data and additionally has a function for moving the instruction pointer data to a branch destination pointer when the instruction that has been fetched and decoded is a branch instruction and the branch condition is satisfied by the result of the execution unit 13. The fetch address generated by the next instruction pointer generating unit 35 is stored in the register 36 and is supplied to the code RAM 11 via an address bus 71. Data that corresponds to this fetch address is obtained via the data bus 72 as the fetch data φd. The data bus 72 has a bus width equal to two words, so that the obtained data is always two words length. When the instruction codes can have unspecified or variable lengths, such as one word to three words instead of always just two words, it is necessary to trim the instruction code data φc from the fetch data φd at a suitable position and to generate instruction code data φc that straddles a plurality of pieces of fetch data φd. A data alignment unit 37 therefore performs an operation that decodes the fetch data φd and generates instruction code data φc. After this, when the timing for generating the instruction code data φc is reached, a read timing signal φr is outputted and the next instruction code data to be supplied to the execution unit 13 is latched in the register 39. At the same time, the next instruction pointer data φa that is outputted from the next instruction pointer generating unit 35 for fetching the next instruction code data φc is latched in the register 38.

The next instruction pointer data φa and the next instruction code data φc are supplied to the execution unit 13 at the next timing. In the execution unit 13, when the processing that is being internally performed by the presently executed instruction ends, the next instruction execution start timing signal φt is output. By the next instruction execution start timing signal φt, the next instruction pointer data φa is latched in a register 41 for the present instruction pointer, and the next instruction code data φc is latched in a register 42 for the present instruction code. In this way, processing according to the next instruction code φc commences in the execution unit 13. As a debugging function, the execution unit 13 is equipped with a function 44 that interprets the break signal φb, so that when the break signal φb is received, a debugging timing signal φdt is outputted. A selector 43 selects one of the normal timing signal φt and the debugging timing signal φdt, and once a debugging operation starts, the next instruction pointer φa and the next instruction code φc are latched at the debugging timing signal φdt so that the execution unit 13 can be controlled in accordance with the debugging timing.

The PU 5 of the present embodiment is provided with the connection points 31 and 32 for externally outputting the next instruction pointer data φa and the next instruction code data φc that have been latched in the registers 38 and 39. The PU 5 is also provided with the connection point 33 for externally outputting the normal next instruction execution timing signal φt. The data φa, φc, and φt are merely outputted via these connection points 31, 32, and 33, and the PU 5 is constructed so that the use or non-use of such data external to the PU 5 does not affect the control of the PU 5. However, in the VUPU 2 shown in FIG. 4, the break signal φb is fed back from the DU 7 based on the data φa, φc, and φt, so that the VUPU 2 can switch to debugging mode. This is to say, in the present embodiment, the VUPU 2 is constructed so that the functions of the PU 5 and the DU 7 are performed cooperatively. There is no need to duplicate the hardware for fetching and decoding, and debugging can be performed with no significant burden or hardware for monitoring the timing.

The DU 7 is provided with a condition setting unit 51, in which the break condition can be set by the personal computer 4 via the user interface 9, and a break condition detecting unit 55, which compares the break condition with data obtained from the PU 5 and outputs the break signal φb. The condition setting unit 51 includes a register 52, in which the break address condition φta that is one of the break target is set, and a register 53, in which the break data condition φtc that is the other break target is set. The break detecting unit 55 includes comparators 56 and 57, and an AND gate 58. The comparator 56 compares the break address condition φta and the next instruction pointer data φa of the PU 5 obtained via the connection point 61. The comparator 57 compares the break data condition φtc with the next instruction code data φc of the PU 5 obtained via the connection point 62. The AND gate 58 takes a logical AND for the output results of these comparators 56 and 57 and the timing data φt obtained via the connection point 63 and outputs the break signal φb. The break signal φb is supplied to the PU 5 via a register 59.

As explained, using an extremely simple construction with a group of registers 51, which stores data used as the break condition, and a detecting unit 55, which compares such data with data obtained from the processor 5 and outputs the break signal φb, the DU 7 of the present embodiment can supply the break signal φb to the PU 5 at the desired timing. The PU 5 does not need to be controlled in any special way for the DU 7, and when the desired break conditions are met, the break signal φb is supplied from the DU 7 and the PU 5 switches to debugging mode.

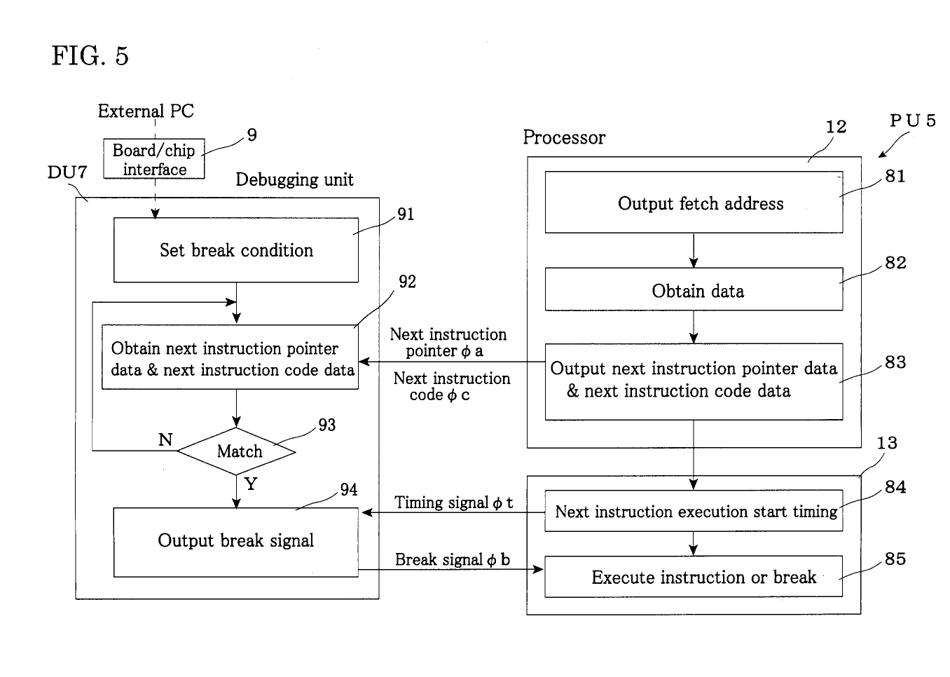

FIG. 5 shows the debugging-related processing of the PU and the DU by means of a flowchart. First in step 81, on the PU 5 side, a fetch stage that is executed by the fetch unit 12 calculates the fetch address for fetching data used to obtain the next instruction code (the next instruction code data) and attempts to read such data out from the code RAM 11. In this step, for fetching a variable-length instruction that is one or two words length, a read is performed with a start address for two-word data that is compatible with the data bus that has a width of two words. In step 82 data that includes the desired next instruction code data is read out from the code RAM 11. In step 83, the decode stage executed by the fetch unit 12 decodes the desired next instruction code data φc from the fetched data φd and stores the next instruction code data φc and the next instruction pointer data φa in the registers 39 and 38 respectively. With the PU 5 of the present embodiment, in the step 83 the generated next instruction code data φc and the next instruction pointer data φa are automatically supplied to the DU 7.

When processing according to the present instruction is completed in the execution stage of the execution unit 13, in step 84 the next instruction code data φc and the next instruction pointer data φa prepared by the fetch unit 12 are inputted into the execution unit 13. At this point, the timing signal φt, which is the signal showing when the data φa and φc are to be inputted, is automatically supplied to the DU 7 from the PU 5. In step 85, if the break signal φb is supplied from the DU 7 while processing is being performed based on this next instruction code data φc, the processing is temporarily halted and the PU 5 switches to debugging mode. So long as the break signal φb is not supplied, regardless of whether the DU 7 is provided or not, the PU 5 operates as normal and so obtains the next instruction code data φc in order and executes processing.

In the DU 7, in step 91, the break address φta and the break data φtc, which form the break condition set in advance by an external host PC 4, are read as the externally set conditions. The execution of the program to be debugged in the PU 5 and in step 92 the next instruction pointer data φa and the next instruction code data φc are received, and the next instruction pointer data φa and the next instruction code data φc are respectively compared with the break address φta and the break data φtc. When the addresses and data match in step 93, in step 94 the break signal φb is outputted to the PU 5 when the timing signal φt is supplied. In this way, in step 85 the PU 5 receives the break signal φb and temporarily halts the processing.

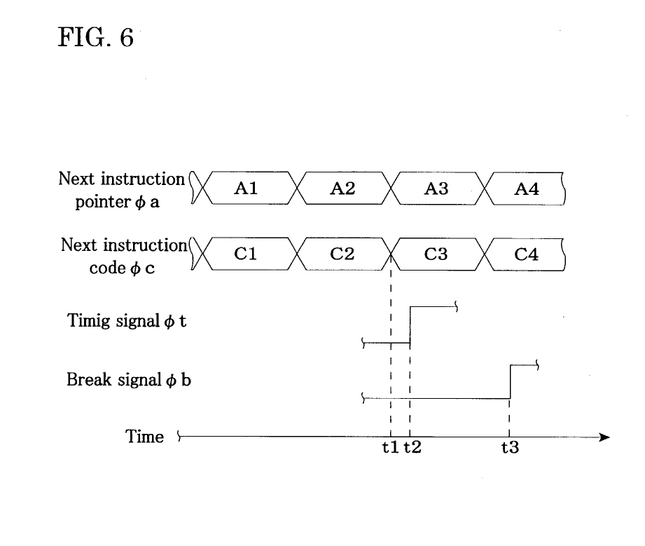

In the timing chart shown in FIG. 6, in the case when the address A3 is set as the break data φta and the instruction C3 is set as the break data φtc, the conditions match in the DU 7 at timing t1 when the next instruction pointer data φa is the address A3 and the next instruction code data φc is the code C3. When the execution timing signal φt for the next instruction is then inputted at timing t2, the break signal φb is generated. This break signal φb is supplied to the PU 5 at the timing t3 of the next clock signal at which the next instruction code data φc is to be executed by the execution unit 13. As a result, the PU 5 temporarily halts its processing at the point where the execution of the instruction C3 is to begin.

The PU 5 is provided with the interface 8 that includes the output terminal 31 for external use of the next instruction pointer data φa, the output terminal 32 for external use of the next instruction code data φc, and the output terminal 33 for external use of the next instruction execution start timing signal φt, with the DU 7 using these signals φa, φc, and φt supplied from the PU 5 to generate the break signal φb and supplying this break signal φb to the PU 5. Therefore, the DU 7 does not need hardware for generating the next instruction pointer data φa, the next instruction code data φc and the next instruction execution start timing signal φt, which makes it possible to avoid the provision of duplicated hardware inside a single LSI 2.

As described above, hardware for outputting the next instruction pointer data φa and the next instruction code data φc is large in cases where the instruction codes have variable lengths and where the length of the instruction codes does not match the width of the data bus. However, in the LSI 2 equipped with the combination of the PU 5 and the DU 7 of the present embodiment, the instruction code data decoded by the processor 5 are commonly used by the DU 7, so that a debugging function of the same construction can be added regardless of whether or not the instruction codes have variable lengths. This is to say, by providing the PU 5 with an additional function for outputting the data φa, φc, and φt, in the DU 7, an address match detection with the next instruction pointer data φa makes it unnecessary for the DU 7 to monitor the instruction length, and a code match detection with the next instruction code data φc makes it unnecessary for the DU 7 to perform a decoding process that aligns the bus data in accordance with an address. Also, since the instruction code that results from branch control on the PU 5 side is obtained, the DU 7 does not need to perform such branch control. The instruction completion timing of the execution stage can be understood from the timing signal φt received from the execution unit 13, so that there is no need for the DU 7 to analyze whether instruction codes are for multicycle instructions.

In addition, the DU 7 also does not need hardware that considers instruction codes that are discarded, such as when a branch condition is satisfied. In the PU 5, instructions that are not executed are not passed over to the execution stage, so that the combination of the next instruction code data φc and the next instruction execution start timing signal φt for latching the next instruction code data φc in the execution stage makes it possible for the DU 7 to reliably monitor the instruction code data that is passed over to the execution stage.

The PU 5 can take the above services of DU 7 by simply providing the points 31 to 33 for outputting the data φa, φc, and φt, so that software and hardware can be designed, developed, and maintained without the presence or absence of a debugging function. The arrangement of the connection points 31 to 33 is not limited to the arrangement described above. Any other hardware that transmits the above described signals or data to an optional unit, such as a debugging unit, at the boundary of the PU 5 of the LSI 2 is sufficient. In the debugging unit of the above, both the next instruction pointer data φa and the next instruction code data φc are received, and both the next instruction pointer data φa and the next instruction code data φc are respectively compared with the break address φta and the break data φtc. The judgment of the brake of processor unit may be made based on at least one of the next instruction pointer data φa and the next instruction code data φc.

The optional unit is not limited to a debugging unit, but a debugging unit is the user unit that can make the most effective use of these signals. By the processor according to this invention, it is possible to design, develop, and maintain, as a processor embedded as a system LSI, a processor that has a standard yet expandable specification, with it also being possible to omit redundant hardware. This means that the present invention makes it possible to provide a processor that is suited to use as an embedded processor with a wide variety of optional functions. It is also possible to provide a PU 5 that is more suited to the VUPU architecture. The present invention is not limited to the VUPU architecture, and by using the present invention for other types of embedded processors, processors with even more optional functions can be provided.

As described above, the present invention provides a processor unit with an interface for outputting the next instruction pointer data and the next instruction code data for external to the processor, thereby making it possible to provide effective state transmission signal lines between the processor embedded and an optional debugging unit. The functions of the embedded processor and the debugging unit can therefore be performed cooperatively, which makes it possible to reduce the hardware requirements of the debugging unit. When constructing a system LSI, the provision of duplicated hardware can be avoided, and optional functions such as a debugging function can be easily implemented. This makes it possible to provide a compact, multi-function system LSI at low cost.

What is claimed is:

1. A data processing apparatus including a processor unit comprising:
a fetch unit for outputting a fetch address based on instruction pointer data and generating instruction code data from data obtained using the fetch address;
an execution unit for executing processing based on the instruction code data;
first output means for externally outputting next instruction pointer data for next instruction code data, which is to be executed next by the execution unit, from the processor unit; and
second output means for externally outputting the next instruction code data from the processor unit.

2. A data processing apparatus according to claim 1,
further including a debugging unit comprising:
break signal output means for supplying a break signal that requests a temporary halt of the processor unit when a break condition is satisfied;
first input means for receiving the next instruction pointer data for comparing with target instruction pointer data set as the break condition; and
second input means for receiving the next instruction code data for comparing with target instruction code data set as the break condition.

3. A data processing apparatus according to claim 2,
wherein the processor unit further comprises third output means for externally outputting start timing, at which processing based on the next instruction code data is to start, from the processor unit,
the debugging unit further comprises third input means for receiving the start timing, and
the break signal output means outputs the break signal at a start of execution of the next instruction code data when at least one of the target instruction pointer data and the target instruction code data respectively matches the next instruction pointer data and the next instruction code data.

4. A data processing apparatus according to claim 2,
wherein the processor unit further comprises third output means for externally outputting completion timing, which shows that processing by the execution unit based on present instruction code data has been completed, from the processor unit,
the debugging unit further comprises third input means for receiving the completion timing as a start timing of execution of the next instruction code, and
the break signal output means outputs the break signal at a start of execution of the next instruction code data when at least one of the target instruction pointer data and the target instruction code data respectively matches the next instruction pointer data and the next instruction code data.

5. A data processing apparatus according to claim 1,
further comprising a special-purpose processing unit including a special-purpose circuit suited to special-purpose processing,
wherein the fetch unit of the processor unit supplies general-purpose instruction code data, which designates processing in the processor unit, to the execution unit as the instruction code data, and supplies special-purpose instruction code data, which designates processing in the special-purpose processing unit, to the special-purpose processing unit as the instruction code data.

6. A processor unit, comprising:
a fetch unit for outputting a fetch address based on instruction pointer data and generating instruction code data from data obtained using the fetch address;
an execution unit for executing processing based on the instruction code data;
first output means for externally outputting next instruction pointer data for next instruction code data, which is to be executed next by the execution unit, from the processor unit; and
second output means for externally outputting next instruction code data from the processor unit.

7. A processor unit according to claim 6,
further comprising third output means for externally outputting timing, at which processing based on the next instruction code data is to start, from the processor unit.

8. A processor unit according to claim 6,
further comprising third output means for externally outputting timing, which shows that processing by the execution unit based on present instruction code data has been completed, from the processor unit.

9. A debugging unit, comprising:
break signal output means for supplying a break signal for requesting a temporary halt of a processor unit when a break condition is satisfied;
first input means for receiving next instruction pointer data for comparing with target instruction pointer data that is set as the break condition, from external to the debugging unit; and
second input means for receiving next instruction code data for comparing with target instruction code data that is set as the break condition, from external to the debugging unit.

10. A debugging unit according to claim 9,
further comprising third input means for receiving timing, which shows when execution of the next instruction code data is to start, from external to the debugging unit,
wherein the break signal output means outputs the break signal at a start of execution of the next instruction code data when at least one of the target instruction pointer data and the target instruction code data respectively matches the next instruction pointer data and the next instruction code data.

11. A method of controlling a debugging unit comprising:
a step of receiving at least one of next instruction pointer data and next instruction code data from external to the debugging unit; the next instruction pointer data for comparing with target instruction pointer data that is set as a break condition, and the next instruction code data for comparing with target instruction code data that is set as a break condition; and
a break requesting step for supplying a break signal, which requests a temporary halt of a processor unit, when the break condition is satisfied.

12. A method of controlling a debugging unit according to claim 11,
further comprising a step of receiving timing, at which execution based on the next instruction code data is to start, from external to the debugging unit,
wherein in the break requesting step, the break signal is output at a start of the execution of the next instruction code data when at least one of the target instruction pointer data and the target instruction code data respectively matches the next instruction pointer data and the next instruction code data.
